(19) United States
(12) Patent Application Publication
(10) Pub. No.: US 2014/0278671 A1
(43) Pub. Date: Sep. 18, 2014

(54) AUTOMATIC PROMOTION GENERATION TO FILL UNBOOKED APPOINTMENT TIME SLOTS OF A SERVICE PROVIDER

(71) Applicant: SCHEDULICITY, INC., Bozeman, MT (US)

(72) Inventors: Tim F. Leonhardt, Bozeman, MT (US); Chad T. Coley, Bozeman, MT (US); Jane E. Crites, Bozeman, MT (US)

(73) Assignee: SCHEDULICITY, INC., Bozeman, MT (US)

(21) Appl. No.: 13/803,705

(22) Filed: Mar. 14, 2013

(51) Int. Cl. G06Q 10/10

(52) U.S. Cl. CPC G06Q 10/1095
USPC 705/7.19

(57) ABSTRACT

Systems and methods for creating automated promotions for services based upon prior appointment bookings for the current service provider or a group of service providers. A service provider or other user may limit the number of automated promotions offered, the services offered, and specify a difference between existing and new customers. Automated promotions are optimized for increasing the usage of services during off-peak times and for services with higher profit margins. Automated promotions are advertised on 3^{rd} party sites in aggregate and summary fashion, with resulting bookings providing the specific promotion details. Embodiments allow for allocation of a portion of the booking fee from a pre-payment by the customer for automated promotions.

### BACKGROUND

Service providers seeking to grow their book of business will often offer discounted services to attract new clients or otherwise increase their sales. Recently, this common business practice has been amplified through the rise of daily deal web sites that work with providers to offer deeply discounted services to hundreds or thousands of potential clients via the internet in the service provider's locale. Sometimes such daily deals are successful, with service providers providing their services to many clients at deep discounts.

However, these deal sites do not consider the scheduling aspects of a business. Specifically, selling 10 or 100 units of a service at a discount then leaves the business with the problem of fitting that promotion into their normal service schedule. The risk is that discounted services will take the place of full priced services, resulting in less income for the business.

Prior approaches have made attempts to integrate discounts into a calendaring system. The present inventors have previously considered, for example, an approach to grouping calendar appointments to optimize a service provider's time (see U.S. Pat. No. 8,244,566, incorporated in its entirety herein). Similarly, the present inventors have also considered how to present promotions in a metered fashion (see U.S. patent application Ser. No. 13/179,222, incorporated in its entirety herein).

Other known approaches include the ability to book promotions based on fixed time slots, either specific to days of the week or time of day. For this approach, the person creating the manual promotion must first know when they have a low occurrence of full price bookings to target those time periods. Commonly this is something that people only know through detailed and time-consuming analysis. Similarly, one does not have insight into what level of discount might entice someone to use a specific day or time. And, historically, these approaches are not integrated with calendaring or booking systems, meaning that there are no tools to help the person creating the offer.

Similarly, other approaches do not consider the difference between promotions for soliciting new users versus an incentive, versus a generic reward. Depending on the business goal of a promotion, the target audience should be either new users or existing customers. If an offer is presented to a person and then rescinded when that person authenticates as an existing customer to collect the reward, that person will become unhappy and less loyal. Similarly, if a promotion is made to collect new customers it should not be available to existing customers. Current systems rely on the user self-identifying whether they are new or existing, restricting the usefulness of the promotion approach.

Using a combination of known approaches, one is easily able to manually create explicit promotions that apply universally for any service booking, combine the manual explicit promotions with additional metering and rules, and integrate promotions with existing scheduling options. Unfortunately, these manual approaches rely on a person creating the promotion, and specifically that the person creating the promotion has full knowledge, skill, and interest in designing effective promotions.

Since designing effective promotions is a very technical skill and best done with extensive knowledge of the customers and market, most people are incapable of manually creating a promotion to entice new customers, fill specific empty calendar slots, or optimize the cost and profit profiles for these activities. Existing approaches attempt to solve pieces of this complex optimization problem, but fail to provide an adequate solution on many fronts.

### SUMMARY

In one general aspect, the present invention is directed to computer-based systems and methods for automatically generating specials or promotions for service providers, and allowing local and external advertising of the promotional specials. The specials are focused on filling empty time slots in a service calendar that would otherwise go unsold. In one embodiment the promotion generating system may allocate part of the booking fee (such as by a payment service) in lieu of other forms of payment. In such embodiments, this may be the only fee that the generator of the promotion receives for automatically generating the promotions (as opposed to subscription fees, etc., for example), making the automatic promotion generation service more economically attractive for the service provider.

In various implementations, the automated generation of specials is simply configured by a business wishing to recruit new customers or optimize their calendar by entering only a few details, for instance the maximum discount they would permit, the total number of promotions sold in a time period, which specific services are allowed for the promotion, and which specific service providers within a business are available for the promotion.

Within the specified parameters, the automated promotion decisions will focus on filling empty time slots that would not otherwise be sold. To make these decisions the data reviewed include historical information about which days and time slots within the promotion period would go unsold. This analysis includes considering the lead time for normal booking to allow normal, full price bookings to have precedence. However, if there are specific slow days or slow time spots, the promotion would prefer those openings. Further, if the day or time is normally busy for the business at large, but not for a specific service provider, then the promotion will use the specific provider time slots for choosing promotions. Certain embodiments may also consider preferring longer appointments or higher profit services or appointment periods.

The historic information used for identifying promotions may further include industry trends at large, or all or some businesses within specific geographic regions or metropolitan areas. In addition to simply identifying the open times that are unlikely to sell at normal rates, the decisions can analyze the likelihood of selling a particular service at a particular time and adjust the discount level to optimize the profit for a given time slot. In this case, as an example, a smaller discount would be offered for a time that has an 80% likelihood of normal, full price booking, but may use a larger discount for a time that only has a 10% chance for a full price booking. Further, lead times for bookings may impact discount rates, allowing different discounts for an appointment in the distant future versus the last minute. Using different discount amounts to optimize revenue provides an advantage to the service provider as opposed to promotions that automatically provide the maximum discount. Further, because in various implementations the customer is required to pre-pay for the service (with the promotion discount) at the time of booking, with the generator of the automated promotion getting a booking fee from the pre-payment, there is an incentive for the generator too to maximize revenue for the service provider, thereby aligning the economic interests of the service provider and the promotion generator.

Similarly, different promotions could be offered to existing customers or to new customers. Customer acquisition is often a goal of businesses, and promotions could be specifically chosen to recruit new customers. Generic discounts are often used to attract these new customers. However, increasing the sales to existing customers is another common business goal. The historic information could consider, for instance, that a customer purchasing a service at a regular six week interval may be incented to increase their purchase rate to every five weeks on occasion, increasing the overall number of services sold to that customer in a year.

These promotions are then made available via advertising. Advertisements could be offered via third party web sites (such as Google, Facebook, eBay, or similar generic site) or via regional sites (such as those specific to Los Angeles or New York) or other destination focused sites (such as individual businesses or affiliate sites), amongst many others. Similarly, the advertisements could be provided locally on the booking site for an individual service provider or group of service providers.

These and other benefits of the present invention will be apparent from the description that follows.

### BRIEF DESCRIPTION OF THE DRAWINGS

The present disclosure will be more readily understood from a detailed description of some example embodiments taken in conjunction with the following figures:

FIG. 1 illustrates a computer-based automated promotion system in accordance with one non-limiting embodiment;

FIG. 2 describes the workflow process for the interaction with an appointment metering system in accordance with one non-limiting embodiment;

FIG. 3 describes the basic steps for promotional offer generation in accordance with one non-limiting embodiment;

FIG. 4 describes the steps for choosing a discount amount associated with an automated offer in accordance with one non-limiting embodiment;

FIG. 5 describes the steps for choosing a time slot popularity profile in accordance with one non-limiting embodiment;

FIG. 6 describes the steps for the automated presentation of a promotion during the booking process in accordance with one non-limiting embodiment;

FIG. 7 is a representation of a user interface for the setup and configuration of the automated promotion system in accordance with one non-limiting embodiment;

FIG. 8 is a representation of a user interface for the review of the automated promotions in accordance with one non-limiting embodiment;

FIG. 9 is a representation of a user interface for the presentation on a 3^{rd} party site of the automated promotions in accordance with one non-limiting embodiment;

FIG. 10 is a representation of a user interface for presentation on a regional scheduling portal of the automated promotions in accordance with one non-limiting embodiment;

FIG. 11 is an alternate representation of a user interface for presentation on a regional scheduling portal of the automated promotions in accordance with one non-limiting embodiment;

FIG. 12 is a representation of a user interface for the existing-customer booking process of the automated promotions in accordance with one non-limiting embodiment;

FIG. 13 is a representation of a user interface for the new-customer booking process of the automated promotions in accordance with one non-limiting embodiment;

FIGS. 14a-14c are example calculations for generating offer scores and discount amounts for time slots in accordance with one non-limiting embodiment.

### DETAILED DESCRIPTION

Various non-limiting embodiments of the present disclosure will now be described to provide an overall understanding of the principles of the structure, function, and use of the appointment metering systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

In various embodiments, the present disclosure is directed to computer-based systems and methods for automatically creating promotions and scheduling appointments resulting from promotions. As used herein, an “appointment” is used to mean an arrangement or reservation for a customer to see a service provider or instructor at a particular time slot, at which time the provider is to provide a service, class, or resource for the customer.

As used herein, a “customer” is a person or entity seeking to schedule an appointment for a service or resource through an online scheduling network. Also, as used in this description, a “service provider” is a business, person, instructor or entity with which the customer seeks to schedule the appointment online. A service provider may offer human and/or non-human resources. The human resources or services provided by the service providers may include: hair styling; massages; physical therapy; workout training; manicures; professional services (e.g., lawyer appointments, accountant appointments, doctor appointments); automobile repair and/or service; golf lessons; acupuncture; music lessons; photographer sessions; yoga/Pilates classes; exercise classes; instructional classes; group tours; other types of instructional classes; etc. Non-human resources refer to resources that do not necessarily require a human service provider, such as the renting of equipment or space provided by the business, such as tennis courts, tanning beds, and conference rooms, etc. In some embodiments, a service provider may include additional service providers associated therewith. For example, a salon may be a service provider and the individual beauticians may also be considered service providers by the present systems and methods. A service provider may be an employee, an independent contractor, or have some other association with the business. In any event, the term “service provider” is used in the description to describe any suitable entity, including businesses and individuals, unless otherwise noted. While the disclosure is written in the context of a business offering promotional services, it is to be appreciated that individual service providers associated with the business can also generate promotions and schedule promotion-based services.

As used herein, a “promotion” or “offer” is any type of discounted, or otherwise augmented advertisement or special that offers services or goods to customers for less than full-rate. While there are a vast array of different types of promotions, some may include, without limitation, goods or services offered at a discounted rate, give-a-ways, buy a certain quantity get a certain quantity_free (e.g., buy one get one free), and volume discounts.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The description of the various embodiments is to be construed as exemplary only and does not describe every possible instance of the inventive subject matter. Numerous alternatives can be implemented, using combinations of current or future technologies, which would still fall within the scope of the claims. The following detailed description is, therefore, not to be taken in a limiting sense, and the scope of the inventive subject matter is defined only by the appended claims.

For illustrative purposes, various embodiments may be discussed below with reference to an appointment scheduling system. This is only one example of a suitable environment and is not intended to suggest any limitation as to the scope of use or functionality of the inventive subject matter. Neither should it be interpreted as having any dependency or requirement relating to any one or a combination of components illustrated in the example operating environments described herein.

Referring now to FIG. 1, one example embodiment of the present disclosure may comprise a computer-based automated promotion system 100 that is configured to create promotion objects and schedule appointments based on one or more automatically discovered parameters. The automated promotion system 100 may be provided using any suitable processor-based device or system, such as a personal computer, laptop, server, mainframe, or a collection (e.g., network) of such computer devices, for example. The automated promotion system 100 may comprise an automated promotion computer device 102 that may include one or more processors 112 and one or more computer memory units 114. For convenience, only one processor 112 and only one memory unit 114 are shown in FIG. 1. The processor 112 may execute software instructions 116 stored in the memory unit 114. The processor 112 may be implemented as an integrated circuit (IC) having one or multiple cores. The memory 114 may include volatile and/or non-volatile memory units. Volatile memory units may include random access memory (RAM), for example. Non-volatile memory units may include read only memory (ROM), for example, as well as mechanical non-volatile memory systems, such as, for example, a hard disk drive, an optical disk drive, etc. The RAM and/or ROM memory units may be implemented as discrete memory ICs, for example.

When the processor 112 of the automated promotion system 100 executes the instructions 116, the processor 112 may be caused to perform the various operations of the automated promotion system 100, such as analyze prior scheduling data, define a promotion object, allow the promotion object to be distributed, receive a redemption request, and schedule an appointment based on at least one automated promotion parameter, as discussed in more detail below. Data used by the automated promotion system 100 may be from various sources, such as an appointment calendar database 118, which may be an electronic computer database, for example, that stores data about promotions being offered by various service providers. The data stored in the appointment calendar database 118 may be stored in a non-volatile computer memory 120, such as a hard disk drive, a read only memory (e.g., a ROM IC), or other types of non-volatile memory. Data may also be stored in a special offers database 122, which may be an electronic computer database, for example, that stores data about the service providers, such as location(s), services provided, prices, etc. The data stored in the special offers database 122 may be stored in a non-volatile computer memory 124, such as a hard disk drive, a read only memory (e.g., a ROM IC), or other types of non-volatile memory. Data may also be stored in an client database 126, which may be an electronic computer database, for example. The data stored in the client database 126 may be stored in a non-volatile computer memory 128, such as a hard disk drive, a read only memory (e.g., a ROM IC), or other types of non-volatile memory. The appointment database 118 may store appointment data for the various service providers. As is to be appreciated, various types of data may also be stored in other databases, such as a distribution channel database and a scheduling system database, as indicated by database 130.

As shown in FIG. 1, the automated promotion system 100 may include several computer servers. For example, the automated promotion system 100 may include one or more web servers 131 and application servers 133. For convenience, only one web server 131 and one application server 133 are shown in FIG. 1, although it should be recognized that the invention is not so limited. The web server 131 may provide a graphical web user interface through which users of the system may interact with the automated promotion system 100. The web server 131 may accept requests, such as HTTP requests, from a customer, and serve the customer responses, such as HTTP responses, along with optional data content, such as web pages (e.g., HTML documents) and linked objects (such as images, etc.).

The automated promotion system 100 may be in communication with a variety of other devices via an electronic communications network 132. The communications network 132 may include a number of computer and/or data networks, including the Internet, LANs, WANs, GPRS networks, etc., and may comprise wired and/or wireless communication links. In one embodiment, the automated promotion system 100 is in communication with at least one 3^{rd} party web site. The 3^{rd} party web sites 134 (hosted by web servers) may be internet-based and may include, without limitation, a daily deal website, a social networking website, an advertising network, enterprise scheduling systems, or a wide variety of other types of channels. In some embodiments, at least one embodiment may utilize distribution channels such as GROUPON, FACEBOOK and/or TWITTER, for example. The automated promotion system 100 may also be in communication with a service provider 138 via the network 132. The service provider 138 may be any type of entity, such as a restaurant, a salon, a mechanic, a beautician, a dentist, or a wide variety of other types of entities, for example. The automated promotion system 100 may also be in communication with one or more scheduling systems 136. The scheduling system 136 may be an online (e.g., web-based) scheduling system, an application-based scheduling system, or any other type of suitable computer-based scheduling system that includes a suitable database for storing the schedule data. The scheduling system 136 may store data about past (historical) appointments, including the time of the appointment and the type of service provider, as well as data about future, scheduled appointments, again including the time of the appointment and the type of service to be provided. In some embodiments, the scheduling system 136 is an enterprise-based scheduling system associated with a service provider 138. In some embodiments, the scheduling system 136 is a component of automated promotion system 100. In other embodiments, the automated promotion system 100 queries the scheduling systems 136 of various service providers 138, as discussed in more detail below, to ascertain available appointment slots for presentment to a customer. The scheduling system 136 may also report appointment information to the automated promotion system 100 (e.g., for promotion-based appointments scheduled by the service provider independent of the automated promotion system 100). This transfer of information allows the automated promotion system 100 to include not only client-scheduled appointments but also appointments scheduled by the service provider 138 when the automated promotion system 100 applies automated promotion rules.

In some embodiments, default sets of automated promotion rules may be defined for particular channels to control the in-flow of appointments from the external distribution channels. For example, the service provider may desire to meter the inflow of appointments from digital advertising campaigns and lead-generation services even though the services have not necessarily been discounted. More details about such promotion metering are provided in U.S. patent application Ser. No. 13/179,222, referenced and incorporated above.

Still referring to FIG. 1, the promotion database 122 may store at least one promotion object. The promotion object may be created or defined by a user (e.g., service provider), for example. A promotion object generally defines the parameters of a particular promotion. In one embodiment, the promotion object comprises one or more of the following parameters: a business name; a business ID; a promotion name; a promotion ID; and a promotion description. The promotion object may also define or otherwise indicate promotion parameters, such as a promotion discount that may be calculated by a percentage or absolute discount from regular price of service(s) included in the promotion, for example. The promotion parameters may also comprise the start and end dates for the promotion availability and the promotion redemption dates, as well as the types of services and the providers of service at the service provider to which the automatically generated promotion may apply. The promotion object may also comprise an online scheduling system ID to identify the scheduling system (e.g., scheduling system 136) where the promotion will be scheduled when a client opts-in. In cases where access to an external scheduling system is not available, the user may supply a URL where the defined promotion can be scheduled in the external scheduling system. In such embodiments, the promotion object may also comprise an online scheduling system URL. The promotion object may also identify service provider(s) (e.g., service provider 138) included in the promotion. The promotion object may also identify the service(s) included in the promotion. When creating a promotion, the user may be able to view a list of service providers and/or services available for scheduling via the external scheduling system 136. As is to be appreciated, this functionality may only be available when an external scheduling system can be reached.

The promotion object may also define or indicate at least one distribution channel ID to specify the distribution channel(s) where the promotion will be announced, or otherwise disseminated. Depending on the selected distribution channel, the user may be required to provide additional parameters (such as max bid or budget values in a pay-per-click or pay-per-booking arrangement, for example). The promotion object may also comprise at least one external promotion ID. An external promotion ID may be used by the automated promotion system 100 to link the promotion to one or more matching promotions defined in external systems. For example, the promotion may be linked to a cost-per-booking ad campaign or daily deal special created in an external system (e.g., a computer system associated with the cost-per-click ad campaign service or the daily deal service). The promotion object may also comprise an indication as to whether a promotion splash page (a page that provides details about the promotion) should be displayed to the customer. This indication may be largely channel-specific, since for certain channels (e.g., daily deal sites) the service provider 138 may decide that it is not necessary to educate the customer about the details of the promotion because the customer has already purchased the promotion before starting the scheduling process. In these cases, the automated promotion system 100 can be configured to hide the promotion splash page and instead send the client directly to the promotion scheduling process.

In one embodiment, a metering promotion parameter is defined using an inputted numeric value and a time period selection to establish the maximum number of promotions (based on the inputted numeric value) that can be scheduled within a certain time period (based on the inputted time period selection). In various embodiments, automated metering promotion parameters can be set separately for each distribution channel or set globally for all channels where the promotion may be announced. In various embodiments, a default set of automated metering promotion rules may be defined to control the in-flow of appointments from any external distribution channel, even if the appointments are not associated with a promotion-based service. The configuration of default automated promotion allows the service provider to meter the inflow of appointments from digital advertising campaigns and/or lead-generation services, for example, even when services have not necessarily been discounted via a promotion.

Referring now to FIG. 2, one example embodiment of the present disclosure may comprise a workflow process for generating automated offers 200. For reference herein, Fill My Book (FMB) refers to an automated promotion capability that generates and distributes promotion parameters (e.g., discount amount, type of service, service provider, appointment time slots, etc.) for a service provider, preferably to maximize revenue for the service provider by filling unfilled (or unbooked) appointment time slots of the service with appropriately discounted (e.g., not necessarily maximally discounted) schedulable items. Within the generation of automated offer process 200, work begins with a business enabling the capability 202. The business then configures business rules 204 related to the offer generation process 200 through an easy to use online interface accessible to someone with minimal or no training Rules could include minimum or maximum discount levels, total number of discounts to allow in a given time period (e.g., the promotion time period), specific services allowed for promotions, and specific individual service providers within a business that may or may not accept discount offers, amongst many other possible configuration options. These rules may be stored in one of the databases 118, 122, for example. Upon completion of the rules configuration 204, an automated process for creating special offers for a future time period commences 206, based upon business rules 204 as well as appointment histories as stored in the system database 118. The specific approach to generating promotional offers is discussed in detail later.

After generating a set of offers for a future time period 206, the business user reviews the automatically generated offers to determine their appropriateness 208. Should any offers be deemed unacceptable they may be denied or canceled, at which point the business has the option of generating a new set of offers 206 or skipping offers for that time period. In some embodiments the option to skip offers may be restricted to allow only a certain number of skipped offers per time period. Upon acceptance of a set of zero or more offers for the time period, work continues by providing the approved offers 210.

Still referring to FIG. 2, the providing of offers may occur in a number of ways. If offers are to be provided on external web sites 212, then appropriate national, regional, or local offers are provided on 3^{rd} party web sites 214 via widgets or other advertising interconnection with the scheduling and offer system 100. If a visitor on the 3^{rd} party site selects an advertisement, a referral is tracked 216 and work continues on the specific business scheduling site 138 via the scheduling portal 136 by viewing the specific special offers for the business 220. Even if 3^{rd party site advertising is not enabled, the special offers are displayed on the scheduling portal 136. Clearly some embodiments may choose one advertising path exclusively or use both concurrently. Also, such} 3^{rd} party web sites may be hosted by a web server(s).

Once the potential customer is directed to a specific business offer site 220, the FMB system customizes the offer 222 based on a number of parameters including, but not limited to, which provider was selected, whether the customer is new or already a patron of that business, and which time slots are available. This computation step 222 is explained in more detail later. The customer then books the appointment 224, which may include pre-paying for the service in some embodiments. Also in some embodiments, a third-party payment service (such as PayPal, Stripe, or any other suitable third-party, online payment service) may collect the pre-payment from the customer and allocate (e.g., deposit in an account) a portion of the booking fee for the generator of the automated promotion (e.g., the administrator of the system 100). The remainder of the fee may be allocated to the business 226, subject to other expenses. For example, in some embodiments a referral fee is to be paid to 3^{rd} parties, in which case that fee can be paid either via the system 100 or the business 228.

Referring now to FIG. 3, one example embodiment of the present disclosure may comprise one of several steps for generating automated offers 206. For the services offered, each may be analyzed 304 for historical relevance for future promotions. In some embodiments a variety of analyses are made including: determining if a service is enrolled in FMB 308, whether the service is offered by a service provider enrolled in FMB 310, if the revenue for the service provider fits the rules configuration for the discount amounts and list prices (e.g., assuring a revenue yield above a certain percentage of list price) 312, and if the service (and/or service provider) was not included in prior special(s) 314. If the variety of tests for an embodiment passes, then the service is added to the list of eligible services for a new promotion 316. Once all services have been considered 306, the automated special offer is generated by choosing among a small number of eligible offerings 318. Certain embodiments may choose offers randomly, others may choose based upon pricing, duration, popularity, revenue optimization, schedule optimization, or likelihood of booking. Finally, once a set of offers is chosen 318, a discount amount is selected for each offer item 320, the details of which are covered later.

Referring now to FIG. 4, one example embodiment of the present disclosure may comprise one of several steps for setting a discount amount for each schedulable item 400. When setting the discount amount 320, in some embodiments one automated step is to decide whether to optimize the discount based on the revenue yield of the offer 404. If a revenue optimized offer is chosen, in some embodiments a decision based on previous (e.g. historical) offerings is made 406. If the service was previously offered, then the history of scheduling is analyzed 408. Comparisons against a control offer 414 and variation offers 422, 426 are made to determine which offer (e.g., discount amount) should be used based on comparison against the history of scheduling of that item. If the control comparison 414 is favorable, the control discount 416 is used; if instead a particular variation is favorable 422 then the particular variation is used 424. If multiple variants match threshold criteria 426, then the variant with the highest historical revenue is used 428. If no control or variants are favorable then a new variant is created 434, which in some embodiments may be done by adding or subtracting 5% from the nearest variant. At this point the discount is set for the promotional item(s) 430.

In an alternate path through FIG. 4, in some embodiments if the service has not been previously offered 406, then an analysis occurs to determine whether other providers in the same business, industry or geography have offered the service 412. If one or more other providers are discovered to have made the offer, or at least offer the same service and for which price information is known, then a determination is made about whether particular controls or variants are favorable 420. If there is a favorable variant, then the system calculates a discount 432, which in some embodiments may set the price to a variant that yields the highest historical revenue. Control again resumes with the discount chosen 430. However, if no similar services were offered, or no favorable offer variants are found, control continues with subtracting random amounts from the maximum discount 410 entered in the configuration rules. The historical data for the service providers, e.g., the services provided, the price therefore, and the promotion if any, may be stored in the database 118, for example.

In yet another alternate path through FIG. 4, in some embodiments the discount is not optimized by revenue yield 404. In these embodiments, the maximum discount rate (e.g., input by the service provider when setting up the promotion) is used as a baseline and random amounts, fixed scale amounts, or other variations on amounts are subtracted 410. In some embodiments it is beneficial to use different discount amounts than in previous time periods 418, and new discounts are chosen until that or other, discount criteria are met. When successful, the discount is set for that schedulable item 430. If more discounts are desired 436, control resumes from the beginning of the optimization path 404, otherwise control continues with a determination in some embodiments to vary the discount by time slot popularity 438. If affirmative, a step to verify the time slot popularity profile from historical and other information is performed 440, which is described in more detail later. Upon assessing the time slot popularity, the calculated discount rate is used, in some embodiments, as an initial value for a specialized discount algorithm at booking time 442. In some embodiments the discount algorithm could then use random variations from the calculated discount, scaled or weighted variations based on historical booking likelihoods, or any other variations obvious to one of ordinary skill in the art. Upon choosing a discount rate, the FMB automated special offer is ready for presentation 446, such as through distribution to the third party web sites 134 to make the promotion available to consumers. Alternatively, if time slot popularity is not used 438, then the same discount rate is used for each eligible time slot 444, and the FMB offers are ready to use 446.

Referring now to FIG. 5, one example embodiment of the present disclosure may comprise one of several steps for verifying time slot popularity profiles for each provider 500. When verifying time slot popularities 440, several steps encompassing various embodiments could include determining if the provider has an existing profile 502 that is current 504, and a potential match with historical information and trends 506. If any of these characteristics are negative, then a time slot popularity profile is created 508. Next, an analysis of available historical data (stored in the database 118, for example) is performed 510, which in some embodiments may be a four week window. If insufficient history exists, then in some embodiments a check is made against other providers in the same business 512, which could include comparisons with other businesses in the same industry or region in some embodiments. If a match is found, a time slot popularity profile is sought 514, and if found, is used as an average baseline to create an initial profile for the new provider 516. If, however, no other providers have the same schedule or a time slot popularity profile, then a fixed amount is assigned to all time slots 518. Whether a fixed amount is used 518 or a new profile is created 516, the resulting time slot popularity profile is ready for the FMB offer 550.

In an alternate path through FIG. 5, if sufficient historical information is available 510, then comparisons are made against previous time periods to assign a score to each hour (or other suitable time increment appropriate for the service provider) of availability based on prior activity 520. Various embodiments may make the historical comparison in various ways, including analyzing previous year data, previous quarter data, previous month data, etc. by provider, by business, by industry or region comparable, and at hourly, daily, or weekly granularity, just to name a few. Once the initial scores are chosen, the granular historical information is analyzed 522, which in some embodiments may be the days of the week. A check is made to determine if the provider worked during this time period 524. If the provider did not work during this time period 524 then a check to determine if there is more historical information to analyze 526, and if so that information is analyzed 522, but if not then a score is calculated for each promotion period 528 before making the time slot popularity ready for the offer period 550.

In another alternate path through FIG. 5, if the check on historical provider work periods 524 indicates that the provider did work during that period, then an analysis of the work history is performed 530, which in some embodiments may entail reviewing the hours during a day when work was performed, discounting or excluding those slots that were sold at a discounted rate. Each historical time slot is then checked whether the provider was available 532, whether the slot was empty or was set for personal time 534, whether the slot was booked well in advance 536, with a short lead time 538, or more last minute 540. In various embodiments the time granularity may be considered hourly, daily, or with some other granular aspect, and booking lead times may be greater than 8 days in advance, within 4-7 days in advance, or 0-3 days in advance. Depending on the outcome of the various tests, a variety of scores (e.g., slot lead time scores) could be assigned 544, 546, 548 to each outcome before checking if additional time is available to analyze 542. These scores may be used to determine the discount amount for the promotion as described further below. In some embodiments, higher scores could indicate to not use the time slot for the offer, medium scores for discouraging the use, and low scores for encouraging the use of that time slot for an offer. Alternatively, one of ordinary skill in the art could easily determine other scoring metrics, including, for example, the inverse where high scores indicate the time period should be used and low scores would discourage the use of that time period.

Continuing with FIG. 5, once the time slot popularity profile is ready for upcoming offers 550, the process then determines if there are more providers at the business (e.g., service provider) to analyze 552, and if so begin the full analysis again by determining if that provider has an existing profile 502. Alternatively, if no further providers are available for analysis, processing completes 540 for that business. If multiple businesses are being analyzed, the next business begins the analysis again 300.

Referring now to FIG. 6, one example embodiment of the present disclosure may comprise one of several steps encompassing various embodiments for providing an automated promotion during the booking process 600. When a customer or potential customer follows a promotional advertisement to a booking site 220, the automated system customizes that offer based upon a number of factors 222. In some embodiments that customization process begins with verifying against the business-specified rules 204 that the current number of offers already accepted is below the maximum number that can be sold for the current time period 602. If no promotions are currently available, then a message is displayed informing the user of this condition 604. If there are promotions available, then in some embodiments a check is made to determine if at least one time slot is available for the selected offer 606. If no time slots are available for the selected offer then an appropriate message is displayed to the user 608. Once it is determined that there exist offers available for the selected time period, in some embodiments a check is made to determine if the visitor is signed in (or otherwise identifiable) to the booking system 610 and if they are an existing client 612. If they are determined to be an existing client then the set of discounts available to existing clients is presented 614, but if they were not signed in or are not an existing client, then the set of discounts available to new clients is presented 616. Once the visitor views the relevant available offers, the visitor selects a provider 618. Available dates for the provider offering the discount are shown 620, allowing the visitor to select a date 622. Times for that provider and date at the discounted price are now shown to the visitor 624, allowing the visitor to select a time 626. If the visitor is not already signed in 610, then they are prompted to sign in or sign up for an account 628. They are then checked against the database 126 to determine if they are an existing client 630. If they are, and if they had received a new client booking day/time/price promotion, then they are displayed a message updating the available promotion 632, before continuing to book and in some embodiments pre-pay for the appointment 634.

In some embodiments the order of the steps in FIG. 6 could vary or be combined. For example, it is considered that steps 618 through 626 could be combined into a different holistic calendar view rather than a step-wise process. Similarly, steps 602 and 606 could be reversed and not change the intent of the embodiment. Alternate equivalent variations could be determined by one of ordinary skill in the art.

Referring now to FIG. 7, one example embodiment of the present disclosure may present an online, user interface 700 (e.g., a web page) as the result of the configuration functions 204. In this embodiment the business user configuring the automated promotion system has the ability to set the maximum discount for new clients 702, and for existing clients 704. They are also able to specify the maximum number of appointment slots available for promotions during the time period 706. They can further specify which service providers to use for the promotion 708. Finally, they may specify which services are permitted for generating automated promotions 710.

Referring now to FIG. 8, one example embodiment of the present disclosure may present an online, user interface 800 (e.g., a web page) to review the automatically generated offers 208. In this embodiment the business user is shown the current configuration settings 802 that were specified earlier 700. The business user can also see the current offers automatically generated by the system 804, and the upcoming offers for the next period 806, which they may regenerate or skip. In this embodiment they can further see the historical offers and acceptance rates 808.

Referring now to FIG. 9, one example embodiment of the present disclosure may present an online, advertisement interface on a 3^{rd} party web site 900 to review the automatically generated offers 214. In this embodiment an area of the 3^{rd} party site is dedicated to targeted advertising 902, where multiple promotional offers are presented 904, 906, 908, allowing the site visitor to click through and redeem the promotion.

Referring now to FIG. 10, one example embodiment of the present disclosure may present an online, advertisement interface (e.g., a web page) on the scheduling portal interface 1000 to review the automatically generated offers 218. In this embodiment multiple distinct offer presentation methods are available. First are the promotional advertisements 1002, 1004, 1006 for businesses not necessarily displayed in the result list. Next are the result list of business, including a normal listing with no promotions 1008 as well as one with promotions available, which may provide a distinct access method for standard booking 1010 and booking using special promotions 1012.

Referring now to FIG. 11, an alternate example embodiment of the present disclosure may present an online, advertisement interface (e.g., a web page) on the scheduling portal interface 1100 to allow customers or potential customers to review the automatically generated offers 218. In this embodiment the set of businesses available within a metropolitan region are displayed 1102. Multiple distinct classes of businesses could be displayed 1104 to show the variety of offers available. Within each business class 1104, individual businesses are shown with their specific offers 1106, 1108. In some embodiments, if all offers have been allocated, that condition may be displayed differently 1110.

Referring now to FIG. 12, one example embodiment of the present disclosure may present an online, promotion booking user interface (e.g., a web page) for an existing client 1200 as a result of the booking process 220, 222. The client is identified 1202, and shown a summary of the available promotions 1204 available to them as an established client as well as the individual booking options for each promotion. For each promotion the client is able to select the service provider 1206, which may be distinct depending on the promotion 1212. In this embodiment, once the service provider is selected the available days for the special offer are displayed 1208. Upon selecting an available day, the available times are displayed 1210, allowing the customer to choose the specific discounted appointment that fits their schedule.

Referring now to FIG. 13, one example embodiment of the present disclosure may present an online, promotion booking user interface (e.g., a web page) for a new client 1300 as a result of the booking process 220, 222. The client is not identified 1302, and shown a summary of the available promotions 1304 available to them as a new client as well as the individual booking options for each promotion. For each promotion the client is able to select the service provider 1306, which may be distinct depending on the promotion 1312. In this embodiment, once the service provider is selected the available days for the special offer are displayed 1308. Upon selecting an available day, the available times are displayed 1310, allowing the customer to choose the specific discounted appointment that fits their schedule.

Referring now to FIGS. 14a-14c, one example embodiment of the present disclosure may include a set of calculations similar to what is shown. Referring first to FIG. 14a, a default Discount table is generated based upon the days before an appointment slot expires and the score used for ranking time slot popularity. So for example, the most popular time slots may not be offered at a discount 4-6 days before expiration, but those same time slots may be offered at a 30% discount if still available within 24 hours of expiration. The associated Decrement Table shows adjustments made to the max discount rate to generate the Discount table based on time slot popularity and days to expiration. The various discounts for each of the new and existing customers are further set at initial values 442, and an example random discount calculation seed for a new customer are shown along with a sample service price of $75.

FIG. 14b is a continuation of the example from FIG. 14a using values for the various tables starting with the sample service price of $75. This table thus shows the discount table as filled in with the 0% discount rate reflecting the calculated $75, and subsequent cells updated with their equivalent discounts.

FIG. 14c is a continuation of the example from FIGS. 14a and 14b. The first table shows the various work hours as time slots, and the time slot scores for each day of the week, with non-working days indicated as “Off.” The second table shows the calculated values for each open slot based upon the scores and the discounts associated with each score (as shown in FIGS. 14a and 14b) at the beginning of the promotional period, as well as which time slots are currently booked. Highlighted values and highlighted “Booked” labels indicate promotion amounts or accepted promotion times. The final table in FIG. 14c shows the same table mid-way through the promotional period with the updated values based on the new “days to expiration” values. Notice the change in discount amounts for time slots not yet booked on Thursday morning versus those not yet booked on Monday morning, representing the different scores used for the number of days to expiration from the first table in FIG. 14a. Also notice how some dates changed from “no discount” to a discounted amount based on the change in booking lead time.

Specific elements of FIGS. 14a-14c benefit from further descriptive explanation, now disclosed.

Determining Initial Discount

Assume a proprietary taxonomy exists that allows a comparison of like services across businesses in the same vertical in the same metro area, arriving at a suggested initial discount rate for a new FMB schedulable item (service/provider combination) when the provider's business does not have adequate booking history to determine this value from their own data.

Every schedulable item has an online conversion rate—the ratio of visits to booked appointments. Of interest is not just conversion rate, however—also important is the yield (conversion rate*price, assuming a fixed number of visits). By identifying the most reliable ‘tests’ in the marketplace (those having the most confidence in due to their low standard error rates), it is possible to back into a starting discount when someone starts using FMB. Essentially, the analysis is able to look at everyone—even those not involved with FMB—to determine sell through rates and yield for the same service at different price points. This analysis can then calculate a discount rate that will bring the subject provider's service down to the price point that generates the highest yield based on observables within the community.

After launching with this seed discount rate, the FMB generator will consider that provider's own booking history each time it needs to determine a discount when including the service in future FMB special offers. The point of using the crowd's testing history is to get in the ballpark of an optimal discount rate sooner than otherwise possible by testing random discount rates across time within the business.

Calculating Time Slot Popularity

It is known that certain days of the week and times of the day are more popular than others when it comes to booking appointments. To normalize this into a mechanism that is useful to vary the discounts offered by day of week and time of day, a mechanism to assign a popularity ranking to each hourly time slot based on historical booking trends is used. This ranking is used to offer variable discounts when clients book the FMB Special Offer online.

The mechanism calls for generating a Time Slot Popularity Profile for each provider participating in Fill My Book. Looking backward at the prior four weeks of scheduling history and farther back to analyze the upcoming week's match in prior year, it is possible to calculate the respective popularity of each weekday's hourly time slots based on the lead time required to fill those slots with appointments (e.g. how many days in advance of the appointment's date and time did the appointment get booked). With this approach the most desirable time slots will be booked the farthest in advance. Consider the following detailed, but non-limiting example embodiment for an overview of how this ranking system works.

For each day of the week that an FMB provider is scheduled to work, the prior 4 weeks' appointment data (excluding discounted appointments by assigning a value of 0 to time slots they occupy and ignoring personal time that occupies a time slot by not assigning a value nor including it in the average popularity score) is reviewed to assign a Time Slot Lead Time score to each weekday's hourly start times. Next an average score is calculated for each time slot, rounding to the nearest whole number.

| Time Slot | |
|---|---|
| Lead Time | |
| Score | Explanation |
| 0 | Time did not fill. |
| 1 | Time filled 0 to 3 days in advance. |
| 2 | Time filled 4 to 7 days in advance. |
| 3 | Time filled 8 or more days in advance. |

For this example the ranking system treats all slots booked more than 8 days in advance as the most popular because Fill My Book only considers the next seven days when offering discounted appointments to clients, but a wider booking window (say, 14 days) could be accommodated by modifying the ranking system to be more granular (i.e., adding tiers for times filled 8-10 days and 11-14 days in advance). Similarly, the specific lead score calculation could be performed in a number of equivalent ways using different approaches, where, for example, the current method included a measure of increasing penalty for an offer but instead could equivalently be computed using a preference for an offer in a time slot.

These scores provide a standard indication of the most popular start times (lower scores=less popular time slots). By way of example:

TABLE 1
Monday Time Slot Lead Time Scores

| | | | | | | Upcoming | |
|---|---|---|---|---|---|---|---|
| | | | | | | Week | |
| | | | | | Avg | Prior | Adjusted |
| Hour | Week -1 | Week -2 | Week -3 | Week -4 | Score | Year | Score |
| 9 | 0 | 2 | 1 | 1 | 1 | 2 | 2 |
| 10 | 1 | 2 | 0 | 1 | 1 | 2 | 2 |
| 11 | 1 | 2 | 2 | 1 | 2 | 3 | 2 |
| 12 | Off | 1 | Off | 2 | 2 | 2 | 2 |
| 13 | 0 | 3 | 3 | 0 | 2 | 2 | 2 |
| 14 | 2 | 1 | 1 | 1 | 1 | 2 | 2 |
| 15 | 3 | 0 | 1 | 1 | 1 | 2 | 2 |
| 16 | 3 | 2 | 2 | 3 | 3 | 3 | 3 |
| 17 | 3 | 2 | 3 | 2 | 3 | 3 | 3 |
| 18 | 2 | 1 | 2 | 2 | 2 | 3 | 3 |

To accommodate seasonal scheduling differences due to holidays, special events, etc., the generator will review the business' prior year's appointment data for the upcoming week if it is available. For this example when a lead score is available for a weekday time slot from the prior year, the generator will apply a heavier weight to the prior year score when calculating an average using the following formula: (avg(Week1Hour1Score+Week2 Hour1Score+Week3 Hour1Score+Week4 Hour1Score+2(PriorY earHour1Score). Results are rounded to the nearest whole number.

The intent is to generate these Time Slot Popularity Profiles only when required. Thus in this example the system only creates them for a provider when that provider is included in a Fill My Book Special Offer, and the profile is only regenerated once every four weeks to limit system load. However, because prior year popularity scores could change from week to week (Christmas, Prom, etc.), it is necessary to recalculate the profile if the lead scores for the week in prior year deviate significantly from the current profile's lead scores—even if that means breaking the rule about only updating the profile once every four weeks. Clearly alternative calculation time ranges and periods could be used and still be an equivalent embodiment.

Finally, there will be cases where a new provider signs up for Fill My Book and there doesn't exist adequate historical data to generate a reliable Time Slot Popularity Profile. In that case, the system will use an average of Time Slot Popularity scores from other providers in the same business for the new provider's initial profile; because profiles are only generated once every four weeks, the new provider will have adequate appointment history the second time we generate a profile for him or her.

After generating the Time Slot Popularity Profile for the provider, the system can use those values to determine discounts made available at the time of booking. Assume a provider's Time Slot Popularity Profile looks like this:

| Time Slots | Monday | Tuesday | Wednesday | Thursday | Friday | Saturday | Sunday |
|---|---|---|---|---|---|---|---|
| 9 | 2 | 1 | Off | 1 | 2 | 2 | Off |
| 10 | 2 | 1 | Off | 2 | 2 | 3 | Off |
| 11 | 2 | 2 | Off | 2 | 2 | 3 | Off |
| 12 | Off | Off | Off | Off | 2 | 3 | Off |
| 13 | 2 | 2 | Off | 2 | 3 | 3 | Off |
| 14 | 2 | 2 | Off | 3 | 3 | 3 | Off |
| 15 | 2 | 3 | Off | 3 | 3 | 3 | Off |
| 16 | 3 | 3 | Off | 3 | 3 | 3 | Off |
| 17 | 3 | 3 | Off | 3 | 3 | 3 | Off |
| 18 | 3 | 3 | Off | 3 | 3 | 3 | Off |

If the FMB generator selected a discount of 20% for this provider's schedulable item (a schedulable item is the combination of service+provider), then Monday morning when the FMB Special Offer goes live, the offer matrix might look like this (assuming a $75 service, variant discount of 20%, and a configured max discount of 30%):

| FMB Prices | | | | | | | |
|---|---|---|---|---|---|---|---|
| Monday | | | | | | | |
| Morning | Monday | Tuesday | Wednesday | Thursday | Friday | Saturday | Sunday |
| 9 | $ 53.00 | $ 60.00 | Off | Booked | No Discount | No Discount | Off |
| 10 | $ 53.00 | Booked | Off | $ 68.00 | Booked | No Discount | Off |
| 11 | $ 53.00 | $ 68.00 | Off | $ 68.00 | No Discount | Booked | Off |
| 12 | Off | Off | Off | Off | Booked | Booked | Off |
| 13 | $ 53.00 | Booked | Off | $ 68.00 | No Discount | No Discount | Off |
| 14 | $ 53.00 | $ 68.00 | Off | $ 71.00 | No Discount | Booked | Off |
| 15 | Booked | $ 71.00 | Off | Booked | Booked | Booked | Off |
| 16 | Booked | Booked | Off | $ 71.00 | Booked | Booked | Off |
| 17 | $ 53.00 | Booked | Off | Booked | No Discount | No Discount | Off |
| 18 | Booked | $ 71.00 | Off | Booked | Booked | Booked | Off |

By Thursday morning, the offer matrix might look like this:

| FMB Prices | | | | | | | |
|---|---|---|---|---|---|---|---|
| Thursday Morning | Monday | Tuesday | Wednesday | Thursday | Friday | Saturday | Sunday |
| 9 | Expired | Expired | Off | Booked | $ 68.00 | Booked | Off |
| 10 | Booked | Booked | Off | Booked | Booked | Booked | Off |
| 11 | Expired | Expired | Off | $ 53.00 | $ 68.00 | Booked | Off |
| 12 | Off | Off | Off | Off | Booked | Booked | Off |
| 13 | Booked | Booked | Off | $ 53.00 | $ 71.00 | $ 71.00 | Off |
| 14 | Expired | Booked | Off | Booked | Booked | Booked | Off |
| 15 | Booked | Expired | Off | Booked | Booked | Booked | Off |
| 16 | Booked | Booked | Off | $ 53.00 | Booked | Booked | Off |
| 17 | Expired | Booked | Off | Booked | $ 71.00 | $ 71.00 | Off |
| 18 | Booked | Expired | Off | Booked | Booked | Booked | Off |

And by Friday evening, even the remaining Saturday time slots are heavily discounted because they are set to expire within 24 hours:

| FMB Prices | | | | | | | |
|---|---|---|---|---|---|---|---|
| Thursday Morning | Monday | Tuesday | Wednesday | Thursday | Friday | Saturday | Sunday |
| 9 | Expired | Expired | Off | Booked | Expired | Booked | Off |
| 10 | Booked | Booked | Off | Booked | Booked | Booked | Off |
| 11 | Expired | Expired | Off | Expired | Booked | Booked | Off |
| 12 | Off | Off | Off | Off | Booked | Booked | Off |
| 13 | Booked | Booked | Off | Booked | Expired | $ 53.00 | Off |
| 14 | Expired | Booked | Off | Booked | Booked | Booked | Off |
| 15 | Booked | Expired | Off | Booked | Booked | Booked | Off |
| 16 | Booked | Booked | Off | Expired | Booked | Booked | Off |
| 17 | Expired | Booked | Off | Booked | Booked | $ 53.00 | Off |
| 18 | Booked | Expired | Off | Booked | Booked | Booked | Off |

To arrive at these numbers, first take the variant discount supplied by the FMB Generator for the schedulable item and feed it and a decrement seed value (which varies week to week in an effort to introduce unpredictability into the discounts seen by clients) into a formula that calculates a deduction to the variant discount based on the number of days to time slot expiration and the popularity ranking of the time slot. This formula creates a Decrement Table, which is then used to create a Discount Table (Variant Discount-Variant Decrement). When a client attempts to book a schedulable item in an FMB Special Offer, the discounts are applied from this table (calculated at run time) to the list price of the selected schedulable item. Notice that available time slots within 24 hours of expiration are offered at max discount, regardless of their popularity score.

To understand the context where these approaches apply, several narrative examples of the use of the various embodiments follow.

### Example 1

### Standard Automated Promotions

Shelley is a massage therapist. She works for herself and doesn't have anyone to help schedule new appointments or recruit new clients. She currently uses an online scheduling system called Schedulicity for her client bookings. The system works well for her and she has used it for over 18 months. Shelley desires to scale her business with new clients, but as a massage therapist and not a business specialist, she has difficulty figuring out how to optimize her schedules and find new clients. To date she has used pop-up offers with Schedulicity to run fixed promotions for specific time periods, but has discovered that these focus on building loyalty among existing customers. She has also tried working with the Deal Manager functionality within Schedulicity which prompted her to manually create fixed promotions within certain parameters, but learned that because she did not fully understand the configuration she ended up selling some popular times at a discount, displacing income she felt she normally would have collected. While this approach has potential for her, she simply doesn't have the time or energy to learn how to manually configure the system to optimize the discounts for her down times.

At a loss for ideas, Shelley discovers the new “Fill My Book” (FMB) capability to automatically generate promotions. She quickly determines that she need enter only a small number of configuration rules and then let the system determine the best rates and times to book discounted slots. She decides to try it to recruit new clients by offering a deeper discount to them, but also use it within her existing customers to try to incent her inconsistent clients to book more frequently. After configuring the different discount rates of 15% and 30% for existing and new clients and selecting discounts only for her 90 minute massage offerings, she accepts the automated FMB offer suggestions for the following week.

Because the system has sufficient historical data to determine Shelley's busy and slow times, it creates a set of promotions that incent clients to fill in the slow times only. Similarly, since the promotions are advertised on 3^{rd} party sites, Shelly discovers that her business increases during the offer week by 20%! She was able to book regular clients at full price at their preferred times while inconsistent clients filled the shoulder times at only a slight discount and she had a handful of new clients booking during times when she normally had no customers! Unlike other approaches, the fact that her best slots were reserved for her highest paying customers accounted for her to not only be more busy, but also make significantly more money than she had previously when running promotions.

### Example 2

### Increased Frequency

Betty is a hair stylist. She would like to boost her income slightly by optimizing the services she provides to her existing customers. She starts using FMB for existing customers with a maximum discount of 10% to see if she can fill some unused slots in her calendar. After some quick configuration, Betty discovers a booking pattern emerging. She has a number of female clients who historically would have their hair colored every 6 weeks. She notices that these clients accepted small discounts of 10% or less prompting them to get their hair colored every 5 weeks instead of every 6. This increased booking frequency of her regular clients has increased Betty's profits while at the same time increasing her customer loyalty.

### Example 3

### Free Scheduling

Tom is a pet groomer. Tom's business is running pretty well, but he doesn't have the time to handle client bookings efficiently. However, Tom's profit margins are quite low and he is loath to incur additional costs to his business. He discovers that there is a free scheduling product that he can try. The cost of the product is borne by requiring Tom to use an automated promotion service for a minimum of two appointments per week, of which the scheduling service is allocated a portion of the booking fee. Upon investigation, Tom discovers that he can control the amount of discount provided and which services apply, and in addition learns that the promotions don't impact his full value time slots. Tom gives the service a try and discovers that he receives a positive response from his customers and actually is able to fill time slots that otherwise would have gone empty by providing only a small promotional discount. In addition, there were several weeks when the promotions were not accepted by his customers and the scheduling product was thus completely free! Tom discovers that this free service, even when it takes a cut of his fees on a few appointments per week, ends up making him more money than he was making before using the scheduling tool.

### Example 4

### New Clients and Pricing

Eric is a personal trainer. He is new to the Spokane area, and is not sure what the appropriate pricing for his services in that area should be. While he has experience in Seattle, he knows that the price structure is likely different in his new area. When he moved to Spokane he started his own business, and needed to set up his business infrastructure. He discovered an online scheduling tool that he began using. This tool had a capability, called “Fill My Book” (FMB) which Eric recognized as an excellent opportunity to build his client base. Eric began using the automated promotions from FMB to schedule new clients with some success. He was able to learn what prices people would pay for his services by watching which promotions and time slots were used by the Spokane clients.

What Eric did not see is that behind the scenes, FMB generated promotions for this new client (Eric) with no historical booking or pricing information based upon other personal trainers in the Spokane region. FMB was able to research which time slots booked at full price for personal trainers, and which sold only at discounts of varying levels. The aggregate information from the 27 other personal trainers in the region was used to identify potential price points and hours in the day (and even days of the week) when Eric could more efficiently book new customers, and FMB used those aggregate indicators to help Eric build his client base and adapt his pricing to the Spokane region.

### Example 5

### Optimized Services

Amy is a mental health counselor. She provides a number of different types of counseling, but as with all counselors, her profit margins are low. She would like to focus more on the services she offers which provide a higher profit margin, but is unsure how to do that without alienating her current clients. She knows, for instance, that her in-depth sessions last longer and provide a better outcome for her clients, and her profit margins on these sessions are higher because of the increased value to the clients. Unfortunately Amy is unable to book as many of these in-depth sessions as she would like. She discovers that the scheduling service she uses offers a promotional capability called Fill My Book (FMB) and begins using it to try to decrease the empty slots on her calendar while she tries to figure out how to get more people using her in-depth services.

After using FMB for a few weeks, Amy notices that she is performing more of the in-depth services than she had in the past. Upon review of her schedule, she discovers that FMB has focused on providing promotions for the in-depth service because of the higher profit margin and longer time slots for the in-depth bookings What Amy did not notice was that since FMB is allocated a portion of the booking fee for the promotional bookings, it biases the promotions toward the services which will provide the largest return for both the service provider as well as the promotional booking system. The end result is that Amy makes more money not only by filling her calendar more efficiently but with services that have the highest profit, and the FMB service also benefits the scheduling software provider in the same way with aligned goals.

### Example 6

### Optimized Advertising

Schedulicity offers online scheduling software with the Fill My Book automated promotion capability. Schedulicity has dozens of business subscribers, each with hundreds of clients in many regions. When providing the promotions on 3^{rd} party sites, Schedulicity must balance which businesses show offers on the 3^{rd} party sites by providing the sites with an advertising capability that cycles through business without undue bias for any one business. In addition, they use a similar unbiased presentation of promotions on their own scheduling portal. One complication with providing information on 3^{rd} party sites, though, is that the offers must be presented in a generic fashion of a range of discounts available for a provider since the presentation of an offer may be outdated based upon when the offer data is available to the 3^{rd} party site and when a business client may book an appointment; situations exist where 3^{rd} party sites check the promotion information once per day for efficiency, but clients book appointments throughout the day, potentially consuming all available promotions. As such, the various advertising presentations show summaries and if a customer clicks through the advertisement to a booking page the remaining updated promotions, if any, are shown and appropriate messages are provided when their promotion choice is no longer available.

In various embodiments, therefore, the present invention is directed to computer-based systems and methods for generating an automated promotion for a service provider, where the automated promotion is for a schedulable item that is defined by at least a type of service and a provider of the service, and where the schedulable item can be scheduled by a customer for an unbooked appointment time slot of the service provider within a promotion time period that lasts from a promotion start time to a promotion end time. In various implementations, the system comprises at least one computer database 118, 122, 130, 136 for storing: (i) service provider data that comprises schedule data about unbooked appointment time slots for the service provider within the promotion time period; and (ii) historical appointment data that comprises data regarding services that were provided at past appointment time slots over a historical time period. As described above, the historical appointment data could be historical appointment data for the service provider, one or more other service providers in a same industry as the service provider, and/or one or more other service providers in a same geographic region as the service provider. The system may also comprise at least one processor 112 in communication with the at least one database. The at least one processor may programmed to determine the promotion parameters for the schedulable item by determining a discount amount for one or more unbooked appointment time slots of the service provider over a remaining portion of the promotion time period. As described above, the discount amount may be determined based on at least: (i) a time remaining until the promotion end time; (ii) a popularity of the type of service of the schedulable item that is based on the historical appointment data stored in the at least one database; and (iii) a popularity of the one or more unbooked appointment time slots of the service provider over the remaining portion of the promotion time period that is based on the historical appointment data stored in the at least one database. The at least one processor may also be programmed to distribute the promotion parameters such that a customer can schedule the schedulable item at the applicable discount rate.

In various implementations, the at least one processor is programmed to determine the discount amount by optimizing the discount amount based on revenue yield for the service provider. As such, in various embodiments, the discount amount for at least one unbooked appointment time slot during the promotion time period is greater after the start of the promotion time period than the discount amount for the at least one unbooked appointment time slot at the start of the promotion period, as can be seen by comparing the examples of Tables 2 and 3 of FIG. 14C. More generally, assuming the promotion time period last N days, and the discount amount for an unbooked appointment time slot on the N^{th} day of the promotion time period may be greater on the N−a^{th} day of the promotion time period than on the first day of the promotional time period, where 0≦a≦N−1. Also, at the promotion start time, the discount amount for the schedulable time for a time slot on the 1^{st} day of the promotion time period may be greater than the discount amount for schedulable time for the same time slot on the N^{th} day of the promotion time period, as can be seen in the example of Table 2 of FIG. 14C by comparing the discount amount, for example, of the 9 am time slot on Monday ($53, or a discount of $22) with the 9 am time slot on Friday or Saturday (no discount). The historical appointment data may comprise: (i) appointment data for T days prior to the promotion start time (e.g., prior four weeks); and (ii) appointment data for a same time period in one or prior years as the promotion time period.

The promotion parameters may be distributed to one or more web servers 134 connected to the computer-based system via an electronic communication network 132, where the one or more web servers host a web site through which a customer can book the schedulable item with the promotion. In addition, as described above, the promotion may require the customer to pre-pay a payment amount for the schedulable item at booking time, in which case a booking fee, from the payment amount pre-paid by the customer, may be deposited in an account of the administrator of the computer-based system.

In various implementations, the promotion parameters may be determined by randomly selecting one or more types of services provided by the service provider from a list of types of services provided by the service provider for the promotion or, instead, selecting the types of services based on business data about the one or more types of services. In such an embodiment, the business data that is used may include: (i) price data for the one or more types of services provided by the service provider; (ii) data indicative of a duration time to provide each of the one or more types of services provided by the service provider; and (iii) data indicative of a popularity amount among customers of the service provider for the one or more types of services provided by the service provider. For example, the types of services for the promotion could be selected to maximize revenue for the service provider or to increase a likelihood of a customer booking a schedulable item with the promotion. Also, the promotion parameters may be different depending on whether the customer is a new customer of the service provider or an existing customer.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A computer-based system for generating an automated promotion for a service provider, wherein the automated promotion is for a schedulable item that is defined by at least a type of service and a provider of the service, and wherein the schedulable item can be scheduled by a customer for an unbooked appointment time slot of the service provider within a promotion time period that lasts from a promotion start time to a promotion end time, the system comprising:
at least one computer database for storing:
service provider data that comprises schedule data about unbooked appointment time slots for the service provider within the promotion time period; and
historical appointment data that comprises data regarding services provided at past appointment time slots over a historical time period for one or more of the following:
the service provider;
one or more other service providers in a same industry as the service provider; and
one or more other service providers in a same geographic region as the service provider;
at least one processor in communication with the at least one database, wherein the at least one processor is programmed to:
determine promotion parameters for the schedulable item by determining a discount amount for one or more unbooked appointment time slots of the service provider over a remaining portion of the promotion time period, wherein the discount amount is determined based on at least:
a time remaining until the promotion end time;
a popularity of the type of service of the schedulable item that is based on the historical appointment data stored in the at least one database; and
a popularity of the one or more unbooked appointment time slots of the service provider over the remaining portion of the promotion time period that is based on the historical appointment data stored in the at least one database; and
distribute the promotion parameters such that a customer can schedule the schedulable item at the applicable discount rate.

2. The system of claim 1 wherein the at least one processor is programmed to determine the discount amount by optimizing the discount amount based on revenue yield for the service provider.

3. The system of claim 2, wherein the at least one processor is programmed to determine the promotion parameters such that the discount amount for at least one unbooked appointment time slot during the promotion time period is greater after the start of the promotion time period than the discount amount for the at least one unbooked appointment time slot at the start of the promotion period.

4. The system of claim 3, wherein the promotion time period last N days, and wherein the discount amount for an unbooked appointment time slot on the N^{th} day of the promotion time period is greater on the N−a^{th} day of the promotion time period than on the first day of the promotional time period, where 0≦a≦N−1.

5. The system of claim 4, wherein, at the promotion start time, the discount amount for the schedulable time for a time slot on the 1^{st} day of the promotion time period is greater than the discount amount for schedulable time for the same time slot on the N^{th} day of the promotion time period.

6. The system of claim 1, wherein the historical appointment data comprises:
appointment data for T days prior to the promotion start time; and
appointment data for a same time period in one or prior years as the promotion time period.

7. The system of claim 1, wherein the at least one processor is programmed to distribute the promotion parameters to one or more web servers connected to the computer-based system via an electronic communication network, wherein the one or more web servers host a web site through which a customer can book the schedulable item with the promotion.

8. The system of claim 7, wherein:
the promotion requires the customer to pre-pay a payment amount for the schedulable item at booking time; and
a booking fee, from the payment amount pre-paid by the customer, is deposited in an account of the administrator of the computer-based system.

9. The system of claim 1, wherein the at least one processor is programmed to determine the promotion parameters by randomly selecting one or more types of services provided by the service provider from a list of types of services provided by the service provider for the promotion, wherein service provider data stored in the at least one database comprises data about the types of services provided by the service provider.

10. The system of claim 2, wherein the at least one processor is programmed to determine the promotion parameters by selecting one or more types of services provided by the service provider from a list of types of services provided by the service provider for the promotion based on business data about the one or more types of services, wherein service provider data stored in the at least one database comprises the business data about the one or more types of services.

11. The system of claim 10, wherein the business data that is used by the at least one processor to select the one or more types of services for the promotion comprises data selected from the group consisting of:
price data for the one or more types of services provided by the service provider;
data indicative of a duration time to provide each of the one or more types of services provided by the service provider; and
data indicative of a popularity amount among customers of the service provider for the one or more types of services provided by the service provider.

12. The system of claim 10, wherein the at least one processor is programmed to select the one or more types of service for the promotion to maximize revenue for the service provider.

13. The system of claim 10, wherein the at least one processor is programmed to select the one or more types of service for the promotion to increase a likelihood of a customer booking a schedulable item with the promotion.

14. The system of claim 1, wherein the at least one processor is programmed to determine different promotion parameters based on whether the customer is an existing customer of the service provider or a new customer of the service provider.

15. A computer-implemented method for generating an automated promotion for a service provider, wherein the automated promotion is for a schedulable item that is defined by at least a type of service and a provider of the service, and wherein the schedulable item can be scheduled by a customer for an unbooked appointment time slot of the service provider within a promotion time period that lasts from a promotion start time to a promotion end time, the method comprising:
storing, in at least one computer database:
service provider data that comprises schedule data about unbooked appointment time slots for the service provider within the promotion time period; and
historical appointment data that comprises data regarding services that were provided at past appointment time slots over a historical time period for one or more of the following:
the service provider;
one or more other service providers in a same industry as the service provider; and
one or more other service providers in a same geographic region as the service provider;
determining, by at least one processor that is in communication with the at least one computer database, promotion parameters for the schedulable item by determining a discount amount for one or more unbooked appointment time slots of the service provider over a remaining portion of the promotion time period, wherein the discount amount is determined based on at least:
a time remaining until the promotion end time;
a popularity of the type of service of the schedulable item that is based on the historical appointment data stored in the at least one database; and
a popularity of the one or more unbooked appointment time slots of the service provider over the remaining portion of the promotion time period that is based on the historical appointment data stored in the at least one database; and
distributing, by the least one processor, the promotion parameters such that a customer can schedule the schedulable item at the applicable discount rate.

16. The method of claim 15, wherein determining the discount amount comprises optimizing the discount amount based on revenue yield for the service provider.

17. The method of claim 16, wherein determining the promotion parameters comprises determining the promotion parameters such that the discount amount for at least one unbooked appointment time slot during the promotion time period is greater after the start of the promotion time period than the discount amount for the at least one unbooked appointment time slot at the start of the promotion period.

18. The method of claim 17, wherein, at the promotion start time, the discount amount for the schedulable time for a time slot on the 1^{st} day of the promotion time period is greater than the discount amount for schedulable time for the same time slot on the N^{th} day of the promotion time period.

19. The method of claim 15, wherein the historical appointment data comprises:
appointment data for T days prior to the promotion start time; and
appointment data for a same time period in one or prior years as the promotion time period.

20. The method of claim 15, wherein distributing the promotion parameters comprises distributing the promotion parameters to one or more web servers connected to the computer-based system via an electronic communication network, wherein the one or more web servers host a web site through which a customer can book the schedulable item with the promotion.

21. The method of claim 20, wherein:
the promotion requires the customer to pre-pay a payment amount for the schedulable item at booking time; and
a booking fee, from the payment amount pre-paid by the customer, is deposited in an account of the administrator of the computer-based system.

22. The method of claim 16, wherein determining the promotion parameters comprises selecting one or more types of services provided by the service provider from a list of types of services provided by the service provider for the promotion based on business data about the one or more types of services, wherein service provider data stored in the at least one database comprises the business data about the one or more types of services.

23. The method of claim 22, wherein the business data that is used by the at least one processor to select the one or more types of services for the promotion comprises data selected from the group consisting of:
price data for the one or more types of services provided by the service provider;
data indicative of a duration time to provide each of the one or more types of services provided by the service provider; and
data indicative of a popularity amount among customers of the service provider for the one or more types of services provided by the service provider.

24. The method of claim 22, wherein determining the promotion parameters comprises selecting the one or more types of service for the promotion to maximize revenue for the service provider.

25. The method of claim 22, wherein determining the promotion parameters comprises selecting the one or more types of service for the promotion to increase a likelihood of a customer booking a schedulable item with the promotion.

26. The method of claim 15, wherein determining the promotion parameters comprises determining different promotion parameters based on whether the customer is an existing customer of the service provider or a new customer of the service provider.
